(19) United States
(12) Patent Application Publication
(10) Pub. No.: US 2003/0145178 A1
(43) Pub. Date: Jul. 31, 2003

(54) Circuit and method for detecting multiple matches in a content addressable memory

(76) Inventors: Charles Jiang, Austin, TX (US); Alan Roth, Austin, TX (US)

Correspondence Address: Ralph A. Dowell, Dowell & Dowell, P.C., Suite 309, 1215 Jefferson Davis Hwy., Arlington, VA, 22202, US

(21) Appl. No.: 10/208,012

(22) Filed: Jul. 31, 2002

Related U.S. Application Data
(60) Provisional application No. 60/352,510, filed on Jan. 31, 2002.

(51) Int. Cl. G06F 12/00

(52) U.S. Cl. 711/158; 711/108

(57) ABSTRACT

A priority encoder circuit for detecting multiple match in a CAM, the priority encoder comprising a plurality of inputs each for receiving a respective matchline signal, the inputs being arranged in a predetermined priority order and being enabled by a matchline signal being received thereon; a plurality of outputs corresponding to ones of said inputs; means for enabling one of the outputs corresponding to an enabled input, that is of the highest priority; and a circuit for logically combining a sufficient number of the inputs and outputs of the PE in order to determine whether more than one respective matchline signals has been received, the determination is based on an observation that for every match line input to the PE, there is a corresponding output from the PE and that the highest priority match should have the match line as well as its corresponding priority match output enabled and that if a match line output is enabled but its corresponding output is not, then there is another higher priority match line output; i.e. there must be multiple match line hits.

The present invention relates to the field of content addressable memories (CAM's), and more specifically to a circuit and method for detecting multiple matches in CAMs supporting variable word width searches.

### BACKGROUND OF THE INVENTION

A CAM is an example of a memory device that incorporates an associative memory. Many techniques have been developed for detecting multiple matches or “hits” in an associative memory array. A conventional approach is to take output signals on a match line (ML) and provide them in parallel as inputs to a Multiple Hit Line (MHL). The voltage or current level of the MHL is changed dependent on the number of active match signals generated by the memory array during a search and compare operation. A multiple hit result is detected by comparing the voltage level on the MHL to a Reference Multiple Hit Line (RMHL). The RMHL voltage level is set to mimic a specific condition expected on the MHL.

The RMHL is designed to distinguish between a single and a multiple hit by appropriately sizing transistors connected to the RMHL. Other methods include sensing a current difference, timing difference or any combination thereof between the MHL and the RMHL. These methods usually require a precharging operation of the MHL and RMHL before activating a sensing operation.

Current CAM products support a flexible configuration feature for statically or dynamically switching between various word-width-searching applications such as 72-bit wide word, 144bit wide word or 288-bit wide word. This variable word width feature is useful in various applications, especially for networking applications using Internet Protocol (IP) address look-ups. In order to support flexible configurations, the CAM incorporates additional circuits, which is complicated and consumes more power.

In conventional approaches to detecting multiple hits in content addressable memories, static word width was assumed, so match line outputs could be used directly. However, with variable word width capability there is now a word width dependency and therefore, matches line outputs cannot be used directly.

The conventional approach to multiple hit detection may be better understood by referring to a general CAM structure which comprises a CAM array, a match line sensing block, a multiple hit detection block and a priority encoder (PE) block as illustrated in FIG. 1.

The PE generally comprises a plurality of PE units arranged in stages or tiers. For example FIG. 2 shows a circuit diagram of a hierarchy of PE units in a Two-tier arrangement. Sixteen match line outputs (MLO₀-MLO₁₅) are shown for illustrative purposes. Each PE unit is coupled to receive respective groups of four match line signals as inputs and provides as an output signal only the input that has the highest priority among the active match lines. Each PE unit also provides a match flag signal (MF) as an output indicating that there is a match among inputs. The MA obtained as a result is an address of an enabled match line having the highest priority, generally having the lowest physical address, among a plurality of match lines arranged in array. Since this function about the PE is well known will not be explained further.

This structure is scalable. It should also be noted that the match address (MA) is obtained by supplying the active output signal (PME) of arranged PE units to ROM (Read Only Memory) as inputs. Other approaches for address generation can be employed instead of a ROM to obtain the match address.

As can be seen from FIG. 1, a circuit block MHD separate to the priority encoder block typically performs multiple hit detection. The MHD circuit takes as inputs each of the matchlines and generates an MHit signal if multiple matches have occurred. However in CAMs with flexible word widths, for example if the CAM has a 72-bit word width and two words are combined to provide a 144-bit search, complicated additional circuitry would have to be included with the MHD block in order to instruct the MHD block to ignore a match in the combined words as a multiple match.

Furthermore, timing is also a consideration in flexible word width CAMs. That is, conventional MHD Blocks tend to introduce additional delay or have to have their input signals delayed to accommodate the delay of a preceding priority encoder block or need to synchronize its priority resolver.

Accordingly, there is a need for a simpler circuit than heretofore exists for detecting multiple matches in a variable word width CAM and in which introduces minimal delay in the multi-tier PE structure.

### SUMMARY OF THE INVENTION

An advantage of the present invention is that instead of using a separate circuit block a priority encoder is utilized to determine and indicate whether a multiple hit occurred.

A further advantage of the invention is that in a multi-stage priority encoder arrangement, a multiple hit signal is generated at the same time as the priority encoder signal for each stage and is propogated through subsequent stages of the priority encoder at a speed similar to that of the propagated priority match output.

A still further advantage of the invention is that there is provided a circuit for detecting multiple matches which may be implemented in full logic which minimizes tight circuit margins and which allows automated design tools for design and simulation, such as HSPICE.

In accordance with this invention there is provided a priority encoder circuit for detecting multiple match in a CAM, the priority encoder comprising:

(a) a plurality of inputs arranged in a predetermined priority order each for receiving one of a plurality of matchline signals;

(b) a plurality of outputs each associated with a corresponding ones of said inputs;

(c) means for enabling only one of the outputs to generate a priority match output thereon corresponding to an input activated in said priority order; and;

(d) a circuit for logically combining signals on said inputs and outputs to generate a multiple match signal when a match line signal is enabled but its corresponding output is not, said multiple match signal being generated at a similar time to said priority match output.

### BRIEF DESCRIPTION OF THE DRAWINGS

These and other features of the preferred embodiments of the invention will become more apparent in the following detailed description in which reference is made to the appended drawings wherein:

FIG. 1 is a schematic block diagram of a CAM according to the prior art;

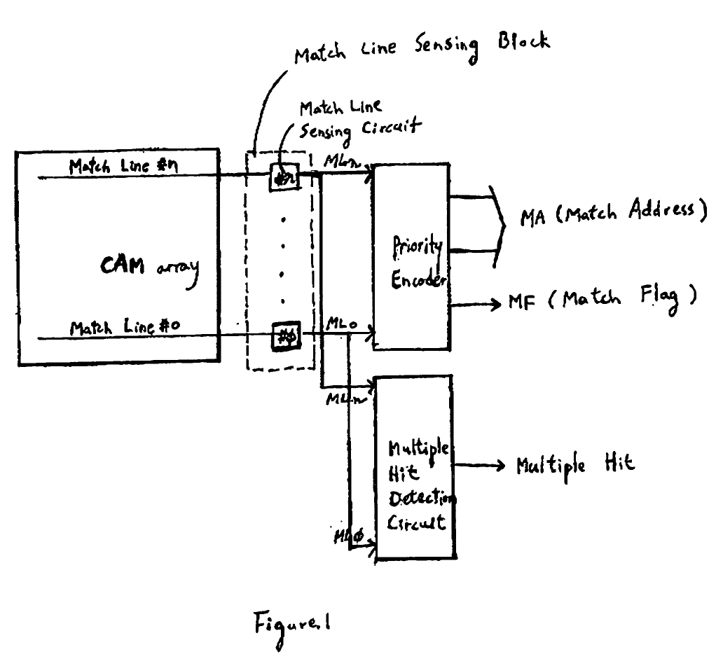

FIG. 2 is a schematic block diagram of a priority encoder;

FIG. 3 is a schematic block diagram of a priority encoder according to an embodiment of the present invention;

FIG. 4 is a schematic block diagram of a multi-tier PE according to an embodiment of the present invention.

### DETAILED DESCRIPTION OF THE PREFRRED EMBODIMENTS

In the following description like numerals refer to like structures in the drawings.

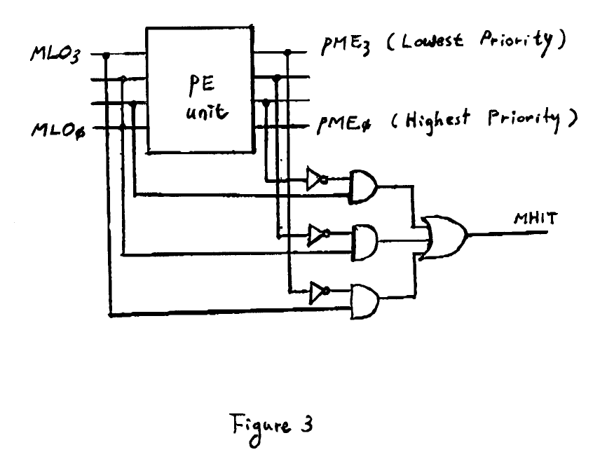

Referring to FIG. 3 there is shown a priority encode (PE) for detecting a multiple match condition in a CAM according to an embodiment of the present invention. As shown the PE has four inputs each for receiving one of four match line signals MLO₀ . . . MLO₃. The inputs have a predetermined priority order, generally the match line having the lowest physical address in the CAM array is assigned the highest priority. The PE includes four outputs PME₀ to PME₃ corresponding to the respective inputs and enables only one output corresponding to the highest priority input which has been driven to a logic “H”, corresponding to receipt of a match line signal thereon. For example, assume that the input receiving MLO₀ is the highest priority match line and MLO₃ is the lowest priority match line, then if the inputs receiving MLO₁ and MLO₃ are enabled, the output corresponding to MLO₁ will be enabled. An example of a circuit for enabling one of the outputs of the PE is described in pending U.S. patent application Ser. No. 09/984,870 by Foss et al. and incorporated herein by reference.

The PE also includes a circuit for logically combining a sufficient number of the inputs and outputs of the PE in order to determine whether more than one respective match line signals has been received, the determination is based on an observation that for every match line input to the PE, there is a corresponding output from the PE and that the highest priority match should have the match line as well as its corresponding priority match output enabled and that if a match line is enabled but its corresponding output from the PE is not, then there is another higher priority match line output; i.e. there must be multiple match line hits. That is the logic for each input may be expressed as follows:

| MLOₙ | PMEₙ | MHIT |
|---|---|---|
| H | H | Don't know |
| H | L | Yes |

Therefore if an input of a PE unit is “Hit”(i.e. enabled or driven to a logic “H”) but the corresponding output of the PE unit is disabled (i.e. driven to a logic “L”), that means there is at least a hit prior to the enabled input, and therefore one can conclude that there are multiple hits including the input itself.

As shown in FIG. 3, a logic circuit for implementing this table, in the four input PE, consists of three AND gates each with its input connected to a respective input of the PE and the other input connected to respective corresponding output of the PE via an inverter. In order to resolve the “don't know” state the outputs of n−1 (where n is the number of inputs to the PE) AND gates must be combined. Thus a subsequent OR gate having three inputs connected to each output of the three AND gates is used to determine a result for a multiple hit detection (MHIT). MHIT is obtained from the output of the OR gate.

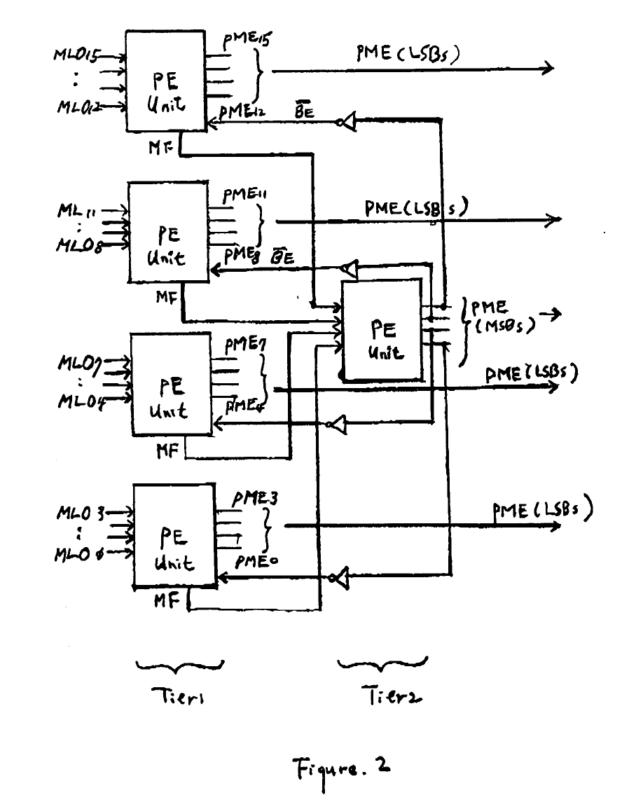

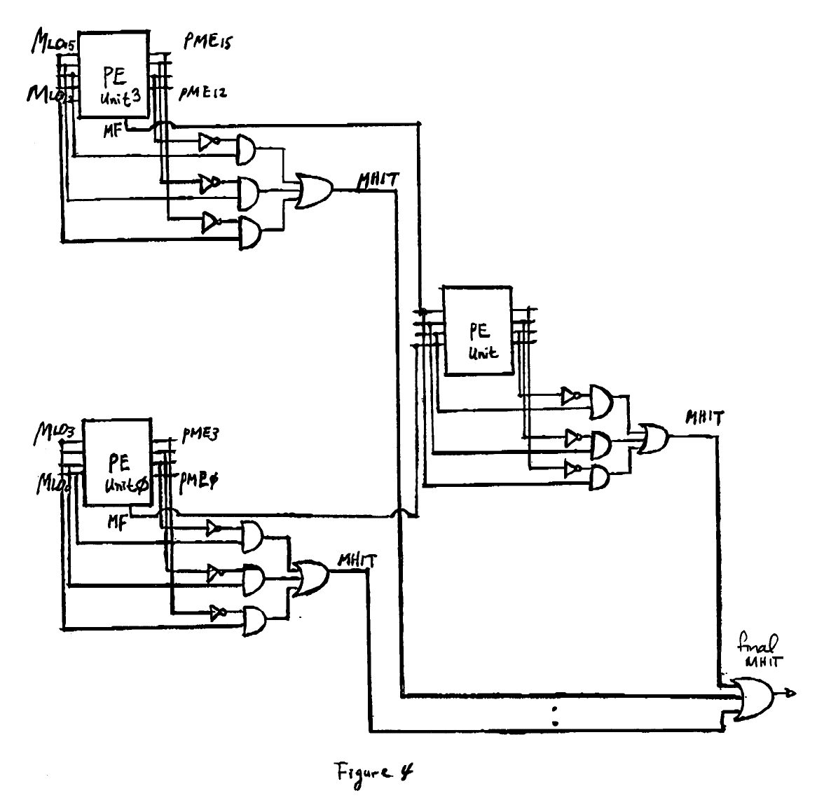

Referring to FIG. 4 there is shown another embodiment of the invention for supporting up to sixteen-match line inputs. In order to support sixteen-match line inputs, the PE comprises four PE units arranged in a first tier and one PE unit arranged in a second tier, respectively. The structure of the second tier PE unit is the same as that in the first tier. Match flags (MF) from the first tier PE units are connected to respective inputs of the second tier PE unit. Outputs of the second tier PE unit are fed back to /BE port of each corresponding first tier PE units to drive outputs of the resolved first tier PE units, via inverters as shown in FIG. 2. The feed back signals have been omitted from FIG. 4 for simplicity. The first tier PE unit outputs a MF signal once priority encoding is finished and one of PME signals is enabled upon receiving the /BE signal provided from the second tier PE. Only one /BE signal from the second tier PE is activated because the highest priority output of the second tier PE is provided. According to This processing, only one first PE unit chosen by the second tier PE unit, which has the highest priority, outputs one PME signal to ROM. /BE port in the second tier PE unit is always enabled. Each PE unit enables MF if there is at least a match in the PE unit.

Each circuit according to the present invention is arranged together with the two tier PE units to get a final result from sixteen inputs. Each output of a multiple hit detection circuit (MHIT) given from the first tier and from the second tier is combined by an additional OR gate as shown in the FIG. 4 and a final multiple hit detection result is obtained. As may be seen, this structure can be expanded to support more match lines by adding a multiple hit detection circuit along with expanded PE units and combining each output from the each multiple hit detection circuit with an OR gate.

Note that any other logic combination for obtaining a result of a multiple hit detection, for example three NAND gates and a following NAND gate having three inputs connected to outputs from the three NAND gates, is also possible.

In order to support variable word-width feature, latched match line results are processed by a variable word width control circuit used to process match line outputs prior to providing the information to the PE unit. The variable word width control circuit is described in a co-pending application U.S. patent application Ser. No. 10/158,196 filed May 31, 2002 by the same applicant and incorporated herein by reference.

In general, the variable word width control circuit (not shown) provides inputs to the PE unit and supplies the latched match line results according to search mode configuration as follows:

It is assumed that the PE unit has 4 inputs connected to the variable word width control circuit.

In a 72-bit search mode configuration, the variable word width control circuit supplies values for four different 72-bit words as the latched match line results to a PE unit; i.e. inputs of the PE unit indicate match result from each 72-bit wide match line.

In a 144-bit search mode configuration, the variable word width control circuit supplies values for two different 144-bit words as the latched match line results to a PE unit; i.e. inputs of the PE unit indicate match results of two 144-bit wide match lines if there is a match. The circuit forces the latched match line associated with the upper 72-bits of the word to a “Hit” condition and the other latched match line associated with the lower 72 bits of the word is forced to a “Miss” condition when there is a match in the 144-bit search mode condiguration.

In a 288-bit search mode configuration, the variable word width control circuit supplies values for one 288-bit word as the latched match line results to a PE unit; i.e. inputs of the PE unit indicate a match result of a 288-bit wide match line if there is a match. The circuit forces the latched match line associated with the upper 72-bits of the word to a “Hit” condition and other three remaining latched match lines associated with the lower part of the word are forced to a “Miss”condition so as not to affect a result from the priority encoder.

In summary, the present invention is useful for supporting a variable word-width CAM. In order to support flexible word width search operation such as 72-bit, 144bit and 288-bit wide dynamically, additional circuits for a PE and a MHD may be needed for conventional approaches.

Since the present circuit is also implemented in CMOS logic, whole circuit in a CAM is fabricated relatively simple and easily with a same process. And less power consumption than conventional approach is expected because no operation for pre-charging is required in the present invention.

While the invention has been described in connection with the specific embodiment thereof and in a specific use, various modifications thereof will occur to those skilled in the art without departing from the spirit of the invention as set forth in the appended claims. The terms and expressions which have been employed in this specification are used as terms of description and not of limitations, there is no intention in the use of such terms and expressions to exclude any equivalence of the features shown and described or portions thereof, but it is recognized that various modifications are possible within The scope of the claims to the invention.

We claim:

1. A priority encoder circuit for detecting multiple match in a CAM, the priority encoder comprising:
(a) a plurality of inputs arranged in a predetermined priority order each for receiving one of a plurality of matchline signals;
(b) a plurality of outputs each associated with a corresponding ones of said inputs;
(c) means for enabling only one of the outputs to generate a priority match output thereon corresponding to an input activated in said priority order, and;
(d) a circuit for logically combining signals on said inputs and outputs to generate a multiple match signal when a match line signal is enabled but its corresponding output is not, said multiple match signal being generated at a similar time to said priority match output.

2. The circuit as defined in claim 1, including a variable word width circuit for forcing groups of input signals to a hit or miss condition in variable word width searches.

3. The circuit as defined in claim 1, wherein the circuit for logically combining signals comprises an AND gate having two inputs connected to an input and an output of the PE unit via an inverter and subsequent OR gate connected to the output of the AND gate.

4. A multiple match detection circuit supporting variable word width searches in a CAM, comprising:
(a) a variable word width circuit, responsive to a search mode signal, for generating N outputs received from a plurality of match lines;
(b) a priority encoder having N outputs and N inputs, the inputs being coupled to the N outputs of the word width circuit and for enabling one of its N outputs corresponding to a highest priority input; and
(c) a circuit coupled to N−1 inputs and N−1 outputs of the priority encoder, for logically combining the N−1 inputs and the N−1 outputs of the priority encoder to determine whether there are multiple matches.
